(19) United States
(12) Patent Application Publication
(10) Pub. No.: US 2016/0097929 A1
(43) Pub. Date: Apr. 7, 2016

(54) SEE-THROUGH DISPLAY OPTIC STRUCTURE

(71) Applicants: Dawson Yee, San Francisco, CA (US); Joshua Hudman, San Francisco, CA (US)

(72) Inventors: Dawson Yee, San Francisco, CA (US); Joshua Hudman, San Francisco, CA (US)

(21) Appl. No.: 14/504,175

(22) Filed: Oct. 1, 2014

(51) Int. Cl. G02B 27/01; G06T 19/00

(52) U.S. Cl. CPC G02B 27/0172; G06T 19/006; G02B 27/0101; G02B 2027/0178; G02B 2027/013; G02B 2027/0132

(57) ABSTRACT

An optical structure useful in a see-through head mounted display apparatus is provided. A first and a second partially reflective and transmissive elements are configured to receive the output of any number of optical sources via an optical element. Each reflective and transmissive element is positioned along an optical viewing axis for a wearer of the device with an air gap between the elements. Each reflective and transmissive element has a geometric axis which is positioned in an off-axis relationship with respect to the optical viewing axis. The off-axis relationship may comprise the geometric axis of one or both elements being at an angle with respect to the optical viewing axis and/or vertically displaced with respect to the optical viewing axis.

### BACKGROUND

A see-through, augmented reality display device system enables a user to observe information overlaid on the physical scenery. To enable hands-free user interaction, a see-through, mixed reality display device system may include see-through optics. Traditional methods for see through display have a number of challenges regarding the optical design and aesthetics. For see through displays, the optics must be folded such that the display is not in the field of view the while still folding the display into the pupil of the view so that the real world and the display can be seen at the same time.

Volume optics such as prisms provide both a distorted field of view to the user and an aesthetically unpleasing appearance.

### SUMMARY

The technology includes a see-through head mounted display apparatus including an optical structure allowing the output of an optical source display to be superimposed on a view of an external environment for a wearer. The image output of any of a number of different optical sources can be provided to a optical element positioned adjacent to the display to receive the output. A first and a second partially reflective and transmissive elements are configured to receive the output from the optical element. Each partially reflective and transmissive element is positioned along an optical viewing axis for a wearer of the device with an air gap between the elements. Each partially reflective and transmissive element has a geometric axis which is positioned in an off-axis relationship with respect to the optical viewing axis. The off-axis relationship may comprise the geometric axis of one or both elements being at an angle with respect to the optical viewing axis and/or vertically displaced with respect to the optical viewing axis.

This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram depicting example components of one embodiment of a see-through, mixed reality display device system.

FIG. 2A is a side view of an eyeglass temple of the frame an optical structure in an embodiment of the see-through, mixed reality display device embodied as eyeglasses providing support for hardware and software components.

FIG. 2B is a top view of an embodiment of an integrated eye tracking and display optical system, and optical structure, of a see-through, near-eye, mixed reality device.

FIG. 3A is a block diagram of one embodiment of hardware and software components of a see-through, near-eye, mixed reality display device as may be used with one or more embodiments.

FIG. 3B is a block diagram describing the various components of a processing unit.

FIG. 4A illustrates a perspective view of an optical structure in accordance with the present technology

FIG. 4B is a second perspective view of the optical structure.

FIG. 4C is a top, plan view of the optical structure.

FIG. 5A is a side view illustrating a ray tracing of the optical structure of the present technology.

FIG. 5B is a second side view illustrating the offset optical axes of the optical structure of the present technology.

FIG. 6 is a distortion graph illustrating the performance of the see-through optical display in accordance with the present technology.

FIG. 7 is a graph of the modulation transfer function (MTF) curve for the present technology.

FIGS. 8A and 8B show the field curvature and distortion, respectively, for an optical structure formed in accordance with the present technology.

FIGS. 9 and 10 are side views of two alternative optical structures formed in accordance with the present technology.

### DETAILED DESCRIPTION

Technology providing a see-through head mounted display apparatus including an optical structure allowing the output of an optical source display to be superimposed on a view of an external environment for a wearer. The image output of any of a number of different optical sources can be provided to a optical element positioned adjacent to the display to receive the output. A first and a second partially reflective and transmissive elements are configured to receive the output from the optical element. Each partially reflective and transmissive element may be aspherical and positioned off-axis with respect to an optical viewing axis for a wearer of the device with an air gap between the elements. Each partially reflective and transmissive element has a geometric axis which is adapted to be offset with respect to the optical viewing axis of a wearer.

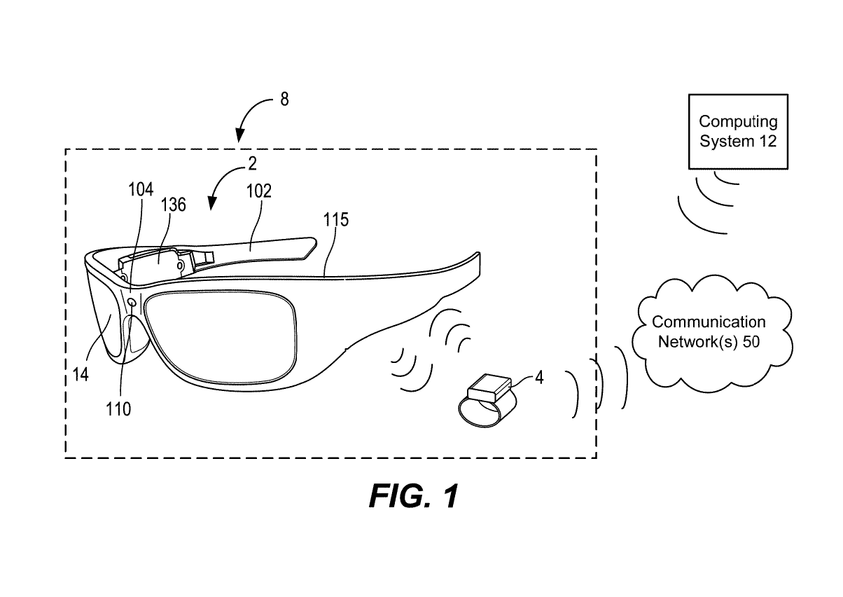

FIG. 1 is a block diagram depicting example components of one embodiment of a see-through, mixed reality display device system. The system 8 includes a see-through display device as a near-eye, head mounted display device 2 in communication with processing unit 4. In other embodiments, head mounted display device 2 incorporates a processing unit 4 in a self-contained unit. Processing unit 4 may take various embodiments in addition to a self-contained unit. For example, processing unit 4 may be embodied in a mobile device like a smart phone, tablet or laptop computer. In some embodiments, processing unit 4 is a separate unit which may be worn on the user's body, e.g. the wrist in the illustrated example or in a pocket, and includes much of the computing power used to operate near-eye display device 2. Processing unit 4 may communicate wirelessly (e.g., WiFi, Bluetooth, infrared, RFID transmission, wireless Universal Serial Bus (WUSB), cellular, 3G, 4G or other wireless communication means) over a communication network 50 to one or more hub computing systems 12 whether located nearby in this example or at a remote location. In other embodiments, the functionality of the processing unit 4 may be integrated in software and hardware components of the display device 2.

Head mounted display device 2, which in one embodiment is in the shape of eyeglasses in a frame 115, is worn on the head of a user so that the user can see through a display, embodied in this example as a display optical structure 14 for each eye, and thereby have an actual direct view of the space in front of the user.

The use of the term “actual direct view” refers to the ability to see real world objects directly with the human eye, rather than seeing created image representations of the objects. For example, looking through glass at a room allows a user to have an actual direct view of the room, while viewing a video of a room on a television is not an actual direct view of the room. Based on the context of executing software, for example, a gaming application, the system can project images of virtual objects, sometimes referred to as virtual images, on the display that are viewable by the person wearing the see-through display device while that person is also viewing real world objects through the display.

Frame 115 provides a support for holding elements of the system in place as well as a conduit for electrical connections. In this embodiment, frame 115 provides a convenient eyeglass frame as support for the elements of the system discussed further below. In other embodiments, other support structures can be used. An example of such a structure is a visor or goggles. The frame 115 includes a temple or side arm for resting on each of a user's ears. Temple 102 is representative of an embodiment of the right temple and includes control circuitry 136 for the display device 2. Nose bridge 104 of the frame 115 includes a microphone 110 for recording sounds and transmitting audio data to processing unit 4.

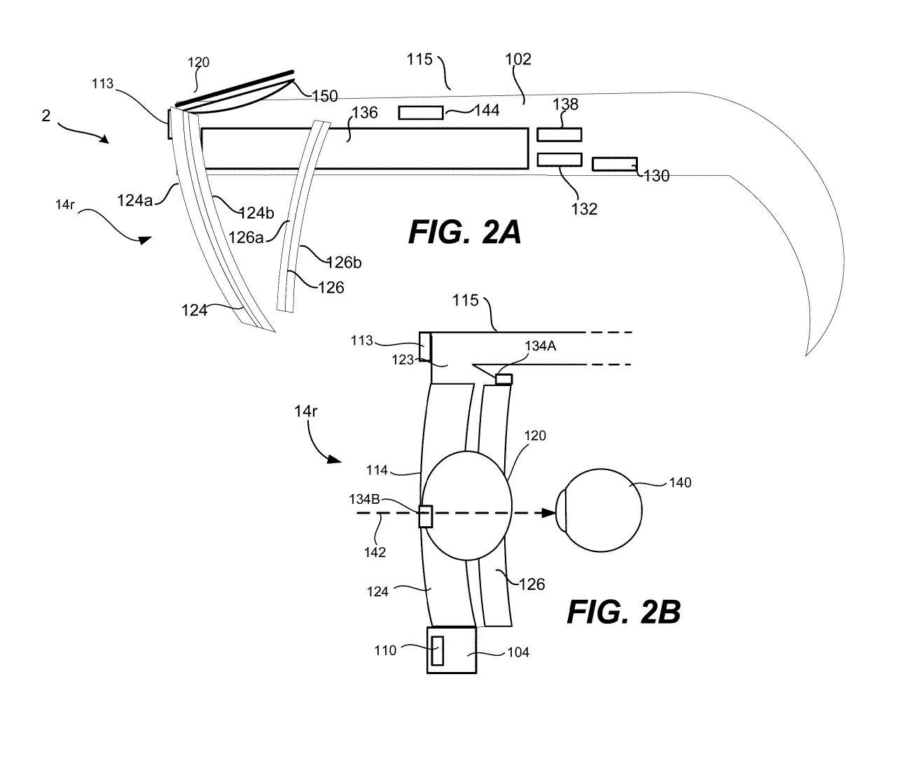

In the embodiments illustrated in FIGS. 2-5B and 9-10, the frame 115 illustrated in FIG. 1 is not illustrated or only partially illustrated in order to better illustrated the optical components of the system

FIG. 2A is a side view of an eyeglass temple 102 of the frame 115 in an embodiment of the see-through, mixed reality display device embodied as eyeglasses providing support for hardware and software components.

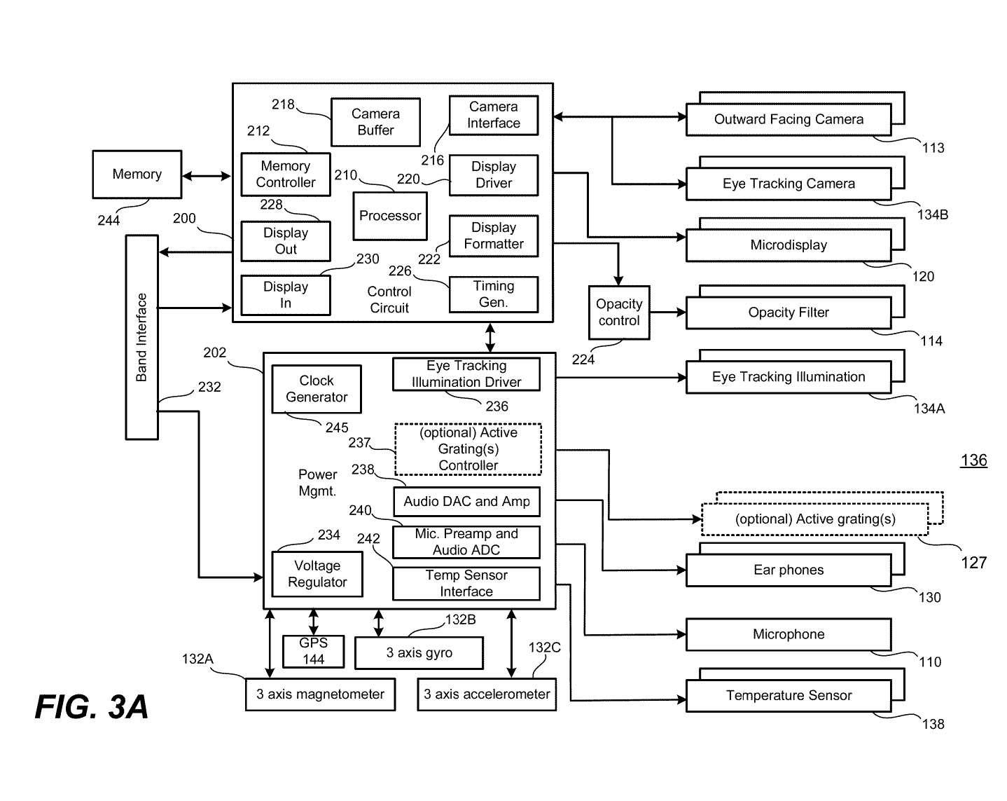

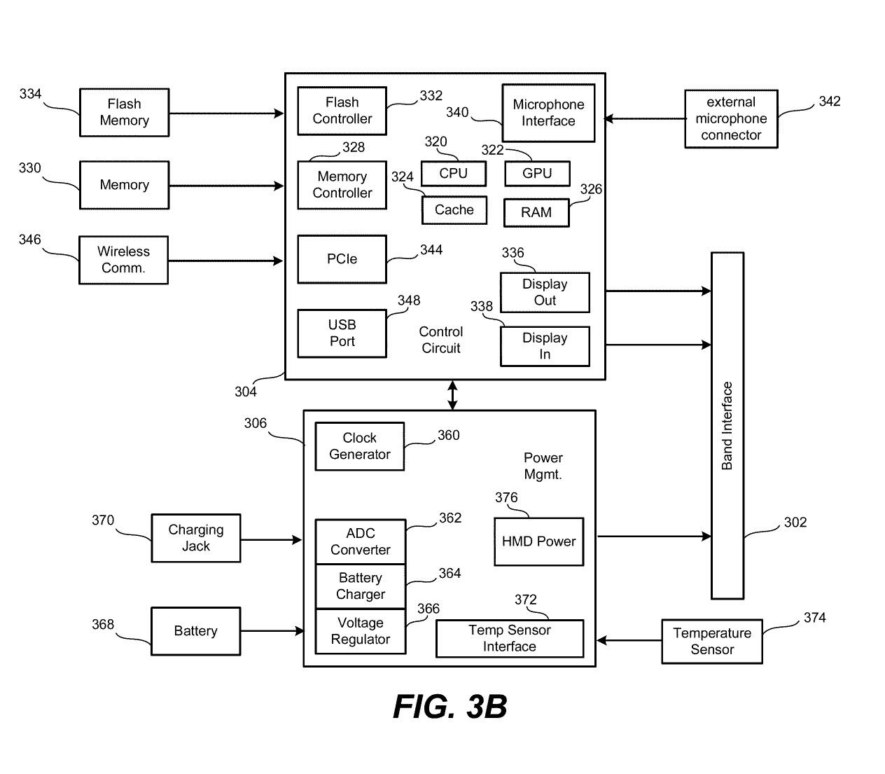

At the front of frame 115 is physical environment facing or outward facing video camera 113 that can capture video and still images which are transmitted to the processing unit 4. The data from the camera may be sent to a processor 210 of the control circuitry 136 (FIG. 3A), or the processing unit 4 or both, which may process them but which the unit 4 may also send to one or more computer systems 12 over a network 50 for processing. The processing identifies and maps the user's real world field of view.

Control circuits 136 provide various electronics that support the other components of head mounted display device 2. More details of control circuits 136 are provided below with respect to FIG. 3A. Inside, or mounted to the temple 102, are ear phones 130, inertial sensors 132, GPS transceiver 144 and temperature sensor 138. In one embodiment, inertial sensors 132 include a three axis magnetometer 132A, three axis gyro 132B and three axis accelerometer 132C. (See FIG. 3A). The inertial sensors are for sensing position, orientation, and sudden accelerations of head mounted display device 2. From these movements, head position may also be determined.

FIG. 2B is a top view of an embodiment of a display optical structure 14 of a see-through, near-eye, augmented or mixed reality device. The optical structure 14 transmits the output of display 120 to any eye 140 of a wearer of the A portion of the frame 115 of the near-eye display device 2 will surround a display optical structure 14 for providing support for one or more optical elements (150, 124, 126) as illustrated herein and in the following figures and for making electrical connections. In order to show the components of the display optical structure 14, in this case 14r for the right eye system, in the head mounted display device 2, a portion of the frame 115 surrounding the display optical system is not depicted.

Mounted above the optical structure 14 and coupled to the control circuits 136 is an image source or image generation unit comprising a micro display 120. In one embodiment, the image source includes micro display 120 for projecting images of one or more virtual objects into an optical structure 14, one side of which, optical structure 14r, is illustrated in FIGS. 2A and 2B.

Any of a number of different image generation technologies can be used to implement micro display 120. For example, micro display 120 can be implemented using a projection technology where the light source is modulated by optically active material, backlit with white light. These technologies are usually implemented using LCD type displays with powerful backlights and high optical energy densities. Micro display 120 can also be implemented using a reflective technology for which external light is reflected and modulated by an optically active material. Digital light processing (DLP), liquid crystal on silicon (LCOS) and Mirasol® display technology from Qualcomm, Inc. are all examples of reflective technologies. Additionally, micro display 120 can be implemented using an emissive technology where light is generated by the display, see for example, a PicoP™ display engine from Microvision, Inc. Another example of emissive display technology is a micro organic light emitting diode (OLED) display. Companies eMagin and Microoled provide examples of micro OLED displays.

In one embodiment, the display optical structure 14r includes an optical element also referred to herein as a optical element 150, a first partially reflective and transmissive element 124, and a second, inner partially reflective and transmissive element 126. Each element 124, 126, allows visible light from in front of the head mounted display device 2 to be transmitted through itself to eye 140 Line 142 represents an optical axis of the users eye 140 through the display optical structure 14r. Hence, a user has an actual direct view of the space in front of head mounted display device 2 in addition to receiving a virtual image from the micro display 120 via the optical structure 14.

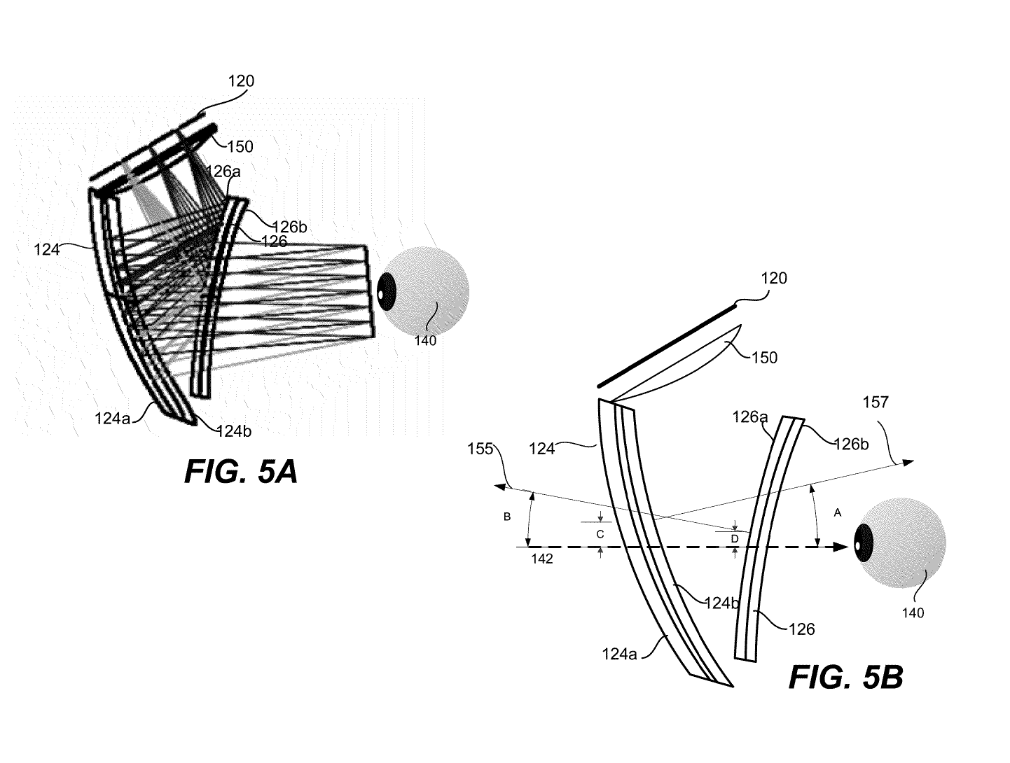

Element 126 has a first reflecting surface 126a which is partially transmissive (e.g., a mirror or other surface) and a second transmissive surface 126b. Element 124 has a first reflecting surface 124b which is partially transmissive and a second transmissive surface 124a. Visible light from micro display 120 passes through optical element 150 and becomes incident on reflecting surface 126a, is reflected to surface 124b and toward eye 140 of a wearer (as illustrated in the ray tracings of FIG. 5A. The reflecting surfaces 126a and 124b reflect the incident visible light from the micro display 120 such that imaging light from the display is trapped inside structure 14 by internal reflection as described further below.

In alternative embodiments, optical element 150 need not be utilized. Use of an optical element 150 allows for creation of a greater field of view than without the element. Removal of the element 150 simplifies the structure 14.

Infrared illumination and reflections also traverse the structure 14 to allow an eye tracking system to track the position of the user's eyes. A user's eyes will be directed at a subset of the environment which is the user's area of focus or gaze. The eye tracking system comprises an eye tracking illumination source 134A, which in this example is mounted to or inside the temple 102, and an eye tracking IR sensor 134B, which is this example is mounted to or inside a brow 103 of the frame 115. The eye tracking IR sensor 134B can alternatively be positioned at any location in structure 14 or adjacent to micro display 120 to receive IR illuminations of eye 140. It is also possible that both the eye tracking illumination source 134A and the eye tracking IR sensor 134B are mounted to or inside the frame 115. In one embodiment, the eye tracking illumination source 134A may include one or more infrared (IR) emitters such as an infrared light emitting diode (LED) or a laser (e.g. VCSEL) emitting about a predetermined IR wavelength or a range of wavelengths. In some embodiments, the eye tracking IR sensor 134B may be an IR camera or an IR position sensitive detector (PSD) for tracking glint positions.

From the IR reflections, the position of the pupil within the eye socket can be identified by known imaging techniques when the eye tracking IR sensor 134B is an IR camera, and by glint position data when the eye tracking IR sensor 134B is a type of position sensitive detector (PSD). The use of other types of eye tracking IR sensors and other techniques for eye tracking are also possible and within the scope of an embodiment.

After coupling into the structure 14, the visible illumination representing the image data from the micro display 120 and the IR illumination are internally reflected within optical structure 14.

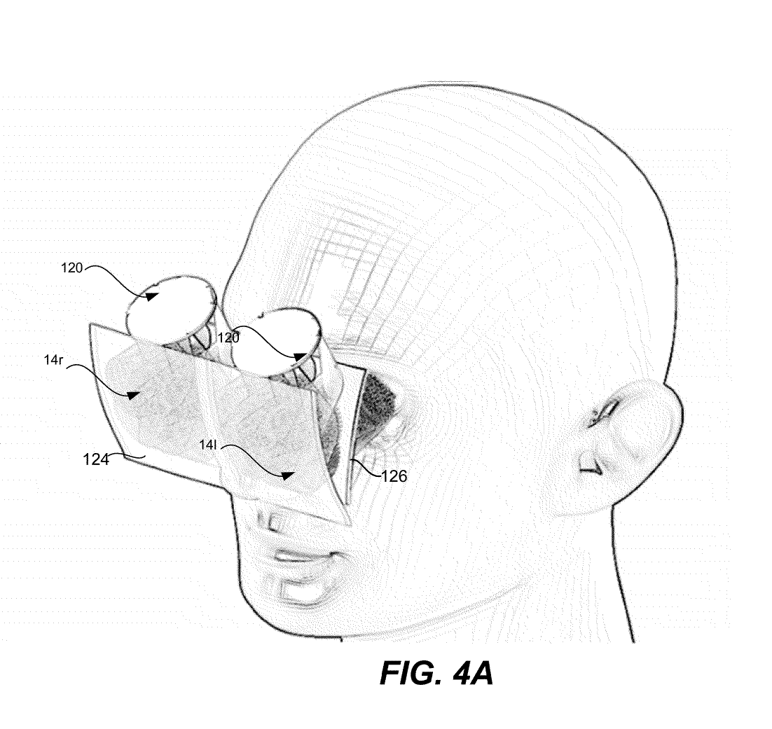

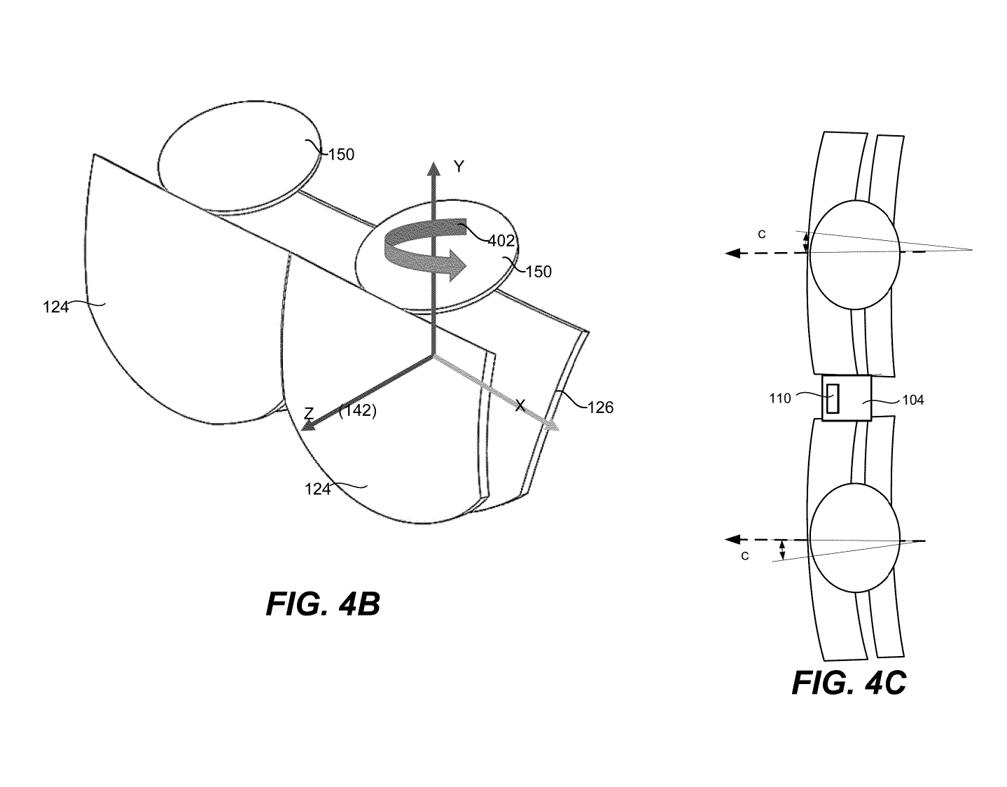

In an embodiment, each eye will have its own structure 14r, 14l as illustrated in FIG. 4A. FIG. 4A illustrates the microdisplays 120 and optical structure 14 relative to a human head, showing light from the displays within the optical structure toward a pair of human eyes 140. When the head mounted display device has two structures, each eye can have its own micro display 120 that can display the same image in both eyes or different images in the two eyes. Further, when the head mounted display device has two structures, each eye can have its own eye tracking illumination source 134A and its own eye tracking IR sensor 134B.

In the embodiments described above, the specific number of lenses shown are just examples. Other numbers and configurations of lenses operating on the same principles may be used. Additionally, FIGS. 2A and 2B only show half of the head mounted display device 2.

FIG. 3A is a block diagram of one embodiment of hardware and software components of a see-through, near-eye, mixed reality display device 2 as may be used with one or more embodiments. FIG. 3B is a block diagram describing the various components of a processing unit 4. In this embodiment, near-eye display device 2, receives instructions about a virtual image from processing unit 4 and provides data from sensors back to processing unit 4. Software and hardware components which may be embodied in a processing unit 4, for example as depicted in FIG. 3B, receive the sensory data from the display device 2 and may also receive sensory information from a computing system 12 over a network 50. Based on that information, processing unit 4 will determine where and when to provide a virtual image to the user and send instructions accordingly to the control circuitry 136 of the display device 2.

Note that some of the components of FIG. 3A (e.g., outward or physical environment facing camera 113, eye camera 134, micro display 120, opacity filter 114, eye tracking illumination unit 134A, earphones 130, one or more wavelength selective filters 127, and temperature sensor 138) are shown in shadow to indicate that there can be at least two of each of those devices, at least one for the left side and at least one for the right side of head mounted display device 2. FIG. 3A shows the control circuit 200 in communication with the power management circuit 202. Control circuit 200 includes processor 210, memory controller 212 in communication with memory 244 (e.g., D-RAM), camera interface 216, camera buffer 218, display driver 220, display formatter 222, timing generator 226, display out interface 228, and display in interface 230. In one embodiment, all of components of control circuit 200 are in communication with each other via dedicated lines of one or more buses. In another embodiment, each of the components of control circuit 200 is in communication with processor 210.

Camera interface 216 provides an interface to the two physical environment facing cameras 113 and, in this embodiment, an IR camera as sensor 1348 and stores respective images received from the cameras 113, 134B in camera buffer 218. Display driver 220 will drive microdisplay 120. Display formatter 222 may provide information, about the virtual image being displayed on microdisplay 120 to one or more processors of one or more computer systems, e.g. 4 and 12 performing processing for the mixed reality system. The display formatter 222 can identify to the opacity control unit 224 transmissivity settings with respect to the display optical structure 14. Timing generator 226 is used to provide timing data for the system. Display out interface 228 includes a buffer for providing images from physical environment facing cameras 113 and the eye cameras 1348 to the processing unit 4. Display in interface 230 includes a buffer for receiving images such as a virtual image to be displayed on microdisplay 120. Display out 228 and display in 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242, active filter controller 237, and clock generator 245. Voltage regulator 234 receives power from processing unit 4 via band interface 232 and provides that power to the other components of head mounted display device 2. Illumination driver 236 controls, for example via a drive current or voltage, the eye tracking illumination unit 134A to operate about a predetermined wavelength or within a wavelength range. Audio DAC and amplifier 238 provides audio data to earphones 130. Microphone preamplifier and audio ADC 240 provides an interface for microphone 110. Temperature sensor interface 242 is an interface for temperature sensor 138. Active filter controller 237 receives data indicating one or more wavelengths for which each wavelength selective filter 127 is to act as a selective wavelength filter. Power management unit 202 also provides power and receives data back from three axis magnetometer 132A, three axis gyroscope 132B and three axis accelerometer 132C. Power management unit 202 also provides power and receives data back from and sends data to GPS transceiver 144.

FIG. 3B is a block diagram of one embodiment of the hardware and software components of a processing unit 4 associated with a see-through, near-eye, mixed reality display unit. FIG. 3B shows controls circuit 304 in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with see-through, near-eye display device 2 via band interface 302 and band interface 232, display in buffer 338 in communication with near-eye display device 2 via band interface 302 and band interface 232, microphone interface 340 in communication with an external microphone connector 342 for connecting to a microphone, PCI express interface for connecting to a wireless communication device 346, and USB port(s) 348.

In one embodiment, wireless communication component 346 can include a Wi-Fi enabled communication device, Bluetooth communication device, infrared communication device, cellular, 3G, 4G communication devices, wireless USB (WUSB) communication device, RFID communication device etc. The wireless communication component 346 thus allows peer-to-peer data transfers with for example, another display device system 8, as well as connection to a larger network via a wireless router or cell tower. The USB port can be used to dock the processing unit 4 to another display device system 8. Additionally, the processing unit 4 can dock to another computing system 12 in order to load data or software onto processing unit 4 as well as charge the processing unit 4. In one embodiment, CPU 320 and GPU 322 are the main workhorses for determining where, when and how to insert virtual images into the view of the user.

Power management circuit 306 includes clock generator 360, analog to digital converter 362, battery charger 364, voltage regulator 366, see-through, near-eye display power source 376, and temperature sensor interface 372 in communication with temperature sensor 374 (located on the wrist band of processing unit 4). An alternating current to direct current converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. Device power interface 376 provides power to the display device 2.

FIG. 4A illustrates the micro displays 120 and optical structure 14 relative to a human head, showing how light from the displays transverses the optical structure toward a pair of human eyes 140. FIG. 4B illustrates a perspective view of the optical structure 14 relative to a coordinate system. FIG. 4C is a plan view of FIG. 4B. As illustrated in FIGS. 4B and 4C, the optical structure 14 may be rotated an angle of C degrees relative to the optical axis 142 to provide a smoother visual contour to the user. In one embodiment, C is in a range greater than zero to about 10 degrees, and may be, for example, seven degrees. Each structure is rotated outward by angle C relative to the bridge 104, as illustrated in FIG. 4C.

FIG. 5A illustrates a ray-tracing of the output of the microdisplay 120 relative to one side of the optical structure 14. As illustrated therein, the output of the micro display 120 (shown as three outputs of, for example red, green and blue light) first passes through optical element 150.

The output of the micro display 120 enters optical structure 14 through optical element 150 and the output light is first reflected by surface 126a from which a first portion of the image light is reflected toward from a partially reflecting surface 124b and then transmitted through element 126 to present an image from the microdisplay 120 to the user's eye 140. The user looks through the elements 124 and 126 to obtain a see-through view of the external scene in front of the user.

A combined image presented to the user's eye 140 is comprised of the displayed image from the micro display 120 overlaid on at least a portion of a see-through view of the external scene,

In various embodiments, the output of the microdisplay 120 may be polarized and the linear polarization of the output maintained so that any of image light from element 120 that escapes from the see-through display assembly 14 has the same linear polarization as the image light provided by the display 120. As shown in FIG. 5B, elements 124 and 126 and the user's optical axis 142 are all located on different optical axes.

Elements 126 and 124 may be formed of, for example, a high-impact plastic and have a constant thickness throughout. In one embodiment, the thickness of element 126 may be about 1.0 mm and the thickness of element 124 may be about 1.5 mm. Each element is formed to by coating a base plastic element with partially reflective and partially transmissive coatings, such as a dielectric coating or metallic film. Using elements 124 and 126, with an air gap between elements, allows the use of standard partially reflective coatings on plastic elements. This increases the manufacturability of the optical structure 14 enhances the system as a whole. Unlike prior structures such as free form prisms, there are no distortions or non-uniform thicknesses imparted by the thick layers of optical material used as waveguides or reflective elements. One or both of elements 124 and 126 may be aspehrical. Furthermore, one of both of elements may be provided “off-axis” such that a user's optical axis (142) passing through the elements 124, 126 when wearing the device is not centered about the geometric axis (axes 155 and 157 in FIG. 5B) of the respective element.

In one embodiment, optical element 150 is provided to increase the field of view of the output of the micro display 120 relative to the elements 124 and 126. In one embodiment, a micro display 120 in conjunction with optical structure 14 provides a 1920×1080 pixel resolution with a field of view of 30 degrees (horizontal) by 19 degrees vertical with a pixel size of about 12 microns.

In another embodiment, optical element 150 may comprise a varifocal lens operating under the control of processing circuitry 136. One example of a varifocal lens suitable for use herein includes and optical lens and an actuator unit which includes deformable regions controlled by a voltage applied thereto which allows the focus of the lens to vary. (See, for example, U.S. Pat. No 7,619,837.) Any number of different types of controllers may be provided relative to lens 152 to vary the prescription of the optical element 150. Alternatively, thin varifocal liquid lenses actuated by electrostatic parallel plates such as Wavelens from Minatech, Grenoble, France may be utilized.

As illustrated in FIG. 5B, in another unique aspect, the elements 124, 126 are at a tilt angle (A,B) and a (vertical) displacement offset (C, D) with respect to the optical axis 142. The optical viewing axis 142 of a user represents the main view axis of a user through system 14. An optical axis 157 of element 124 is offset with respect to axis 142 by an angle A of approximately 30 degrees, and displacement C of 40 mm. The optical axis 155 of element 126 is offset with respect to axis 142 by an angle B of approximately 25 degrees and displacement D of 10 mm. In alternative embodiments, angles A and B may be in a range of 20-45 degrees while vertical offsets C-D may be in a range of 0-40 mm.

The off-axis implementation of the current technology allows for the manufacture of the optical structure 14 using the aforementioned uniform thickness plastics and thin film coatings.

Still further, one or both of elements 124 and 126 may be formed with ashperical surfaces (124a, 124b, 126a, 126b) (shown in cross-section in FIG. 5B).

It should be noted that the partially reflective and transmissive surface 124b of element 124 is concave and in opposition to the convex partially reflective and transmissive surface 126A of element 126. Unlike prior embodiments, an air gap separates elements 124, 126 and 150.

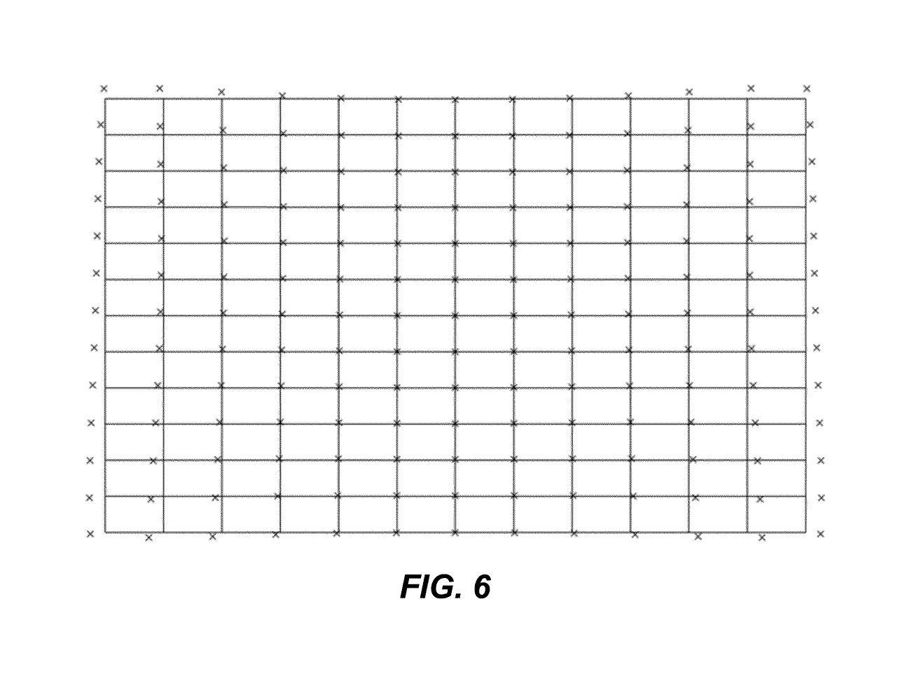

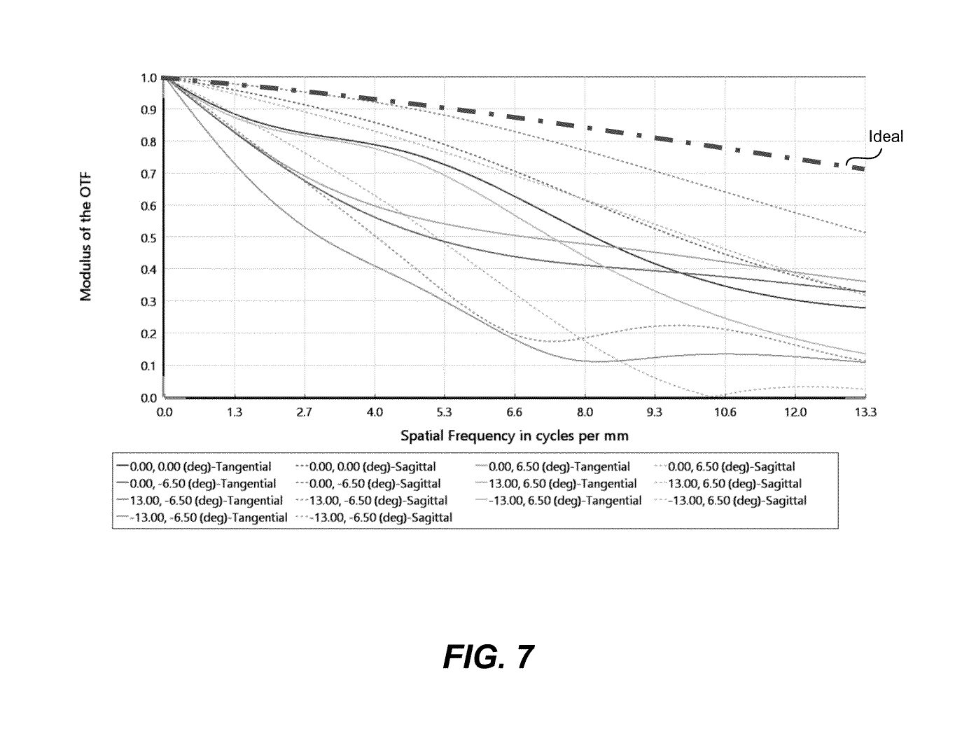

FIG. 6 is a distortion graph illustrating the performance of the see-through optical display in accordance with the present technology. As illustrated therein, the rectangular grid illustrates the ideal performance on a user's view through the optical system, with the “x”s illustrating the amount of distortion present which results from an optical system. As illustrated in FIG. 7, the distortion is not only minimal, but symmetrical across the field of view.

FIG. 7 is a graph of the modulation transfer function (MTF) curve for the present technology. Graphs are shown for two MTF's at each point: one along the radial (or sagittal) direction (pointing away from the image center) and one in the tangential direction (along a circle around the image center), at right angles to the radial direction. An MTF graph plots the percentage of transferred contrast versus the frequency (cycles/mm) of the lines. Each MTF curve is shown relative to the distance from the image center in the sagittal or tangential direction. An ideal MTF curve for the present technology (as determined, by for example a system designer) is based on the desired resolution of the device. The ideal MTF curve and the accompanying curves show the imaging performance for a device created with the present technology. A higher modulation value at higher spatial frequencies corresponds to a clearer image.

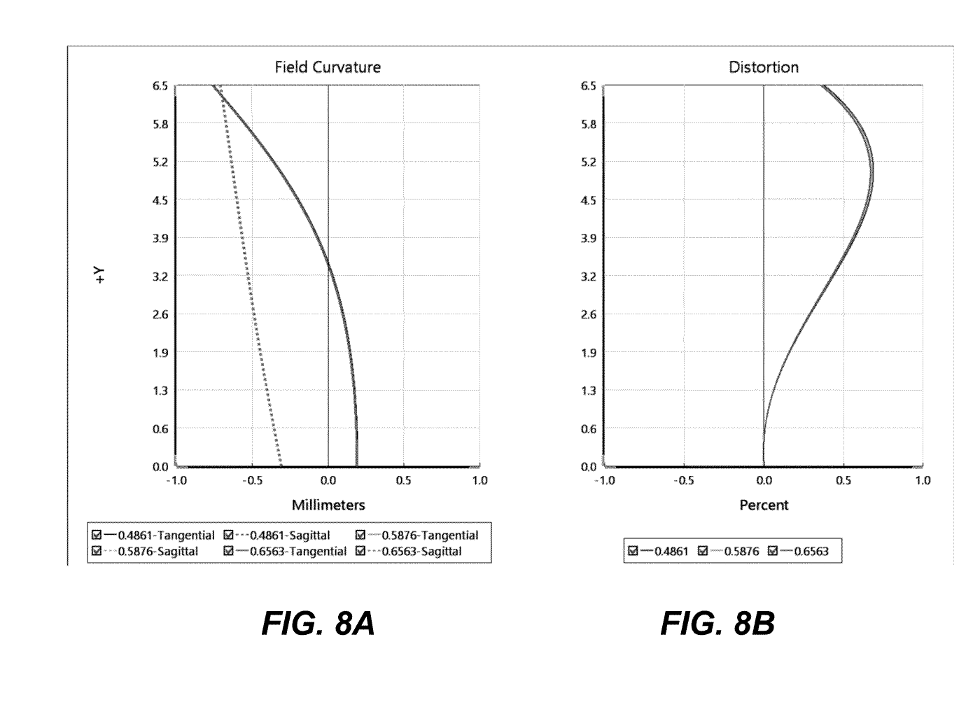

FIGS. 8A and 8B show the field curvature and distortion, respectively, for an optical structure formed in accordance with the present technology.

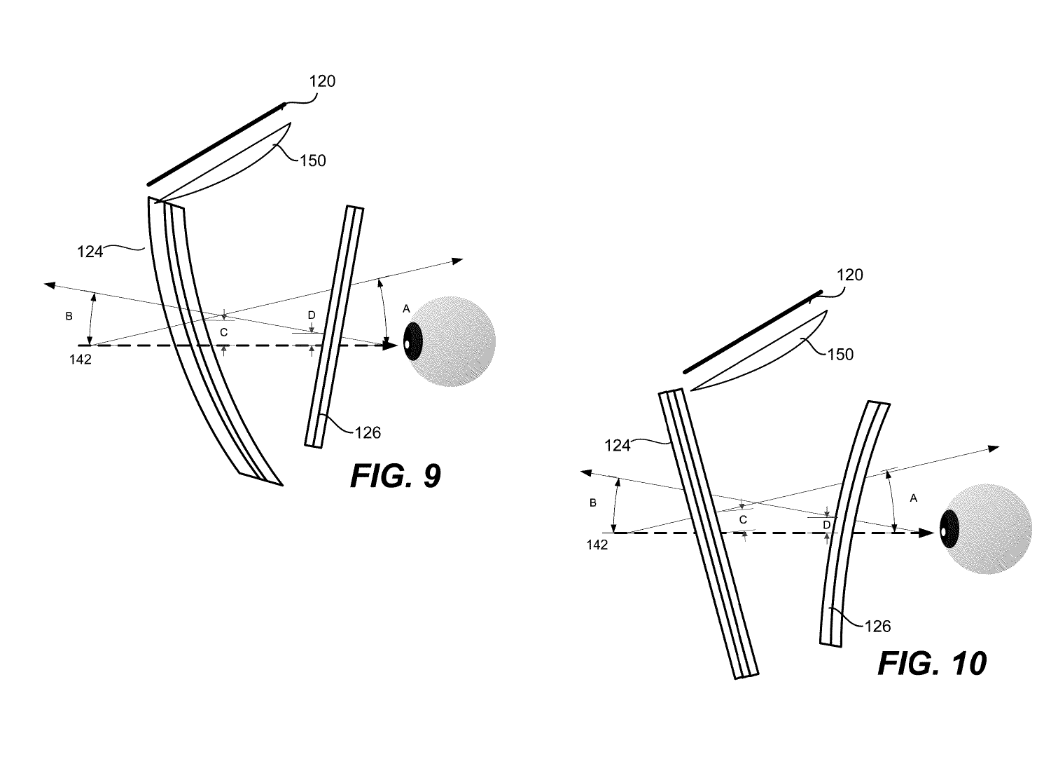

FIGS. 9 and 10 intent illustrate additional embodiments of the present technology. As illustrated therein, one of optical elements 124, 126 may be formed as a planar element. As illustrated in FIG. 9, element 126 be can be provided as a planar element. As illustrated in FIG. 10, element 124 can be formed as a planar element.

### Exemplary Embodiments

In accordance with the above description, the technology includes an optical display system adapted to output an image to an optical viewing axis. The system includes an image source; a first optical element positioned along the optical viewing axis and having an first geometric axis positioned off-axis with respect to the optical viewing axis. A second optical element positioned along the optical viewing axis and having a geometric axis positioned off-axis with respect to the optical viewing axis.

One or more embodiments of the technology include the aforementioned embodiment wherein off-axis comprises the geometric axis positioned at an angle relative to the optical viewing axis.

Embodiments include a system as in any of the aforementioned embodiments wherein off-axis comprises the geometric axis vertically displaced with respect to the optical viewing axis.

Embodiments include a system as in any of the aforementioned embodiments wherein at least one of the optical elements comprises an aspherical optical element.

Embodiments include a system as in any of the aforementioned embodiments further including a third optical element positioned between the image source and the first and second optical elements.

Embodiments include a system as in any of the aforementioned embodiments wherein the third optical element is a varifocal element.

Embodiments include a system as in any of the aforementioned embodiments wherein the first optical element and the second optical element comprise uniform plastic substrates each including at least one partially reflective and transmissive surface.

Embodiments include a system as in any of the aforementioned embodiments wherein the first optical element and the second optical element are separated by an air gap.

Embodiments include a system as in any of the aforementioned embodiments wherein each said element is aspherical, and wherein the at least one partially reflective and transmissive surface of the first element is concave and opposes the at least one partially reflective surface of the second element, the at least one partially reflective surface of the second element being convex.

Embodiments include a system as in any of the aforementioned embodiments wherein at least one of the optical elements comprises a planar element.

One or more embodiments of the technology include a see through head mounted display. The display includes a frame; a display having an output; a first partially reflective and transmissive element; a second partially reflective and transmissive element; each element positioned along an optical viewing axis for a wearer of the frame with an air gap there between such that the first partially reflective and transmissive element has an first geometric axis is positioned off-axis respect to the optical viewing axis; the second partially reflective and transmissive element having an optical axis off-axis with respect to the optical viewing axis; and the elements adapted to provide the output to the optical viewing axis.

Embodiments include a display as in any of the aforementioned embodiments further including a third optical element positioned between the display and the first partially reflective and transmissive element and second partially reflective and transmissive elements.

Embodiments include a display as in any of the aforementioned embodiments wherein at least one optical element is aspherical.

Embodiments include a display as in any of the aforementioned embodiments wherein off-axis comprises at least one said geometric axis positioned at an angle relative to the optical viewing axis.

Embodiments include a display as in any of the aforementioned embodiments wherein off-axis further comprises the at least one said geometric axis vertically displaced with respect to the optical viewing axis.

One or more embodiments of the technology include a display device. The display device comprises: a micro display having an output; an optical element positioned adjacent to the display to receive the output; a first partially reflective and transmissive element configured to receive the output from the optical element; a second partially reflective and transmissive element configured to receive the output reflected from the first partially reflective and transmissive element; and each element positioned along an optical viewing axis for a wearer of the device with an air gap between and having a geometric axis positioned at an angle relative to the optical viewing axis.

Embodiments include a display as in any of the aforementioned embodiments wherein the geometric axis of each element is vertically displaced with respect to the optical viewing axis.

Embodiments include a display as in any of the aforementioned embodiments wherein at least one said element is aspherical.

Embodiments include a display as in any of the aforementioned embodiments wherein each element includes at least one partially reflective and transmissive surface, the surface of the first partially reflective and transmissive element being concave and the surface of the second partially reflective and transmissive element being convex.

Embodiments include a display as in any of the aforementioned embodiments wherein at least one of the partially reflective and transmissive elements is planar.

One or more embodiments of the technology may include the technology includes an optical display means (14) adapted to output an image to an optical viewing axis (142). The display means includes a first means (124) for reflecting and transmitting the image positioned along the optical viewing axis and having a first geometric axis (155) positioned off-axis with respect to the optical viewing axis. A second means (126) reflecting and transmitting the image positioned along the optical viewing axis and having a geometric axis (157) positioned off-axis with respect to the optical viewing axis. A third optical element 150 may comprise means for focusing the image on the first optical means and second optical means.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. An optical display system operable to output an image to an optical viewing axis, comprising:
an image source;
a first optical element positioned along the optical viewing axis and having a first geometric axis at the optical viewing axis that is positioned off-axis with respect to the optical viewing axis;
a second optical element positioned along the optical viewing axis and having a second geometric axis at the optical viewing axis that is positioned off-axis with respect to the optical viewing axis.

2. The system of claim 1 wherein off-axis comprises the geometric axis positioned at an angle relative to the optical viewing axis.

3. (canceled)

4. The system of claim 1 wherein off-axis comprises the geometric axis vertically displaced with respect to the optical viewing axis.

5. The system of claim 1 wherein at least one of the optical elements comprises an aspherical optical element.

6. The system of claim 1 further including a third optical element positioned between the image source and one of the first and second optical elements.

7. The system of claim 1 wherein the first optical element and the second optical element comprise uniform plastic substrates each including at least one partially reflective and transmissive surface.

8. The system of claim 7 wherein the first optical element and the second optical element are separated by an air gap.

9. The system of claim 8 wherein each said element is aspherical, and wherein the at least one partially reflective and transmissive surface of the first element is concave and opposes the at least one partially reflective surface of the second element, the at least one partially reflective surface of the second element being convex.

10. The system of claim 1 wherein at least one of the optical elements comprises a planar element.

11. A see through head mounted display, comprising:
a frame;
a display having an output;
a first partially reflective and transmissive element located below the display when worn on a user's head;
a second partially reflective and transmissive element located below the display when worn on the user's head;
each element positioned along an optical viewing axis for a wearer of the frame with an air gap therebetween such that
the first partially reflective and transmissive element has a first geometric axis at the optical viewing axis that is positioned off-axis respect to the optical viewing axis;
the second partially reflective and transmissive element having an optical axis at the optical view axis that is positioned off-axis with respect to the optical viewing axis; and
the elements operable to provide the output to the optical viewing axis.

12. The display of claim 11 further including a third optical element positioned between the display and the first partially reflective and transmissive element.

13. The display of claim 12 wherein at least one optical element is aspherical.

14. The display of claim 13 wherein off-axis comprises at least one said geometric axis positioned at an angle relative to the optical viewing axis.

15. The system of claim 14 wherein off-axis further comprises the at least one said geometric axis vertically displaced with respect to the optical viewing axis.

16. A display device, comprising:
a micro display having an output;
a optical element positioned adjacent to the display to receive the output;
a first partially reflective and transmissive element configured to receive the output from the optical element;
a second partially reflective and transmissive element configured to receive the output reflected from the first partially reflective and transmissive element; and
each of the first partially reflective and transmissive element and the second partially reflective and transmissive element having an axis positioned along an optical viewing axis for a wearer of the device with an air gap between and having a geometric axis positioned at an angle relative to the optical viewing axis.

17. The device of claim 16 wherein the geometric axis of each element is vertically displaced with respect to the optical viewing axis.

18. The device of claim 16 wherein at least one said element is aspherical.

19. The display device of claim 16 wherein each of the optical element, first partially reflective and transmissive element and second partially reflective and transmissive element includes at least one partially reflective and transmissive surface, the surface of the first partially reflective and transmissive element being concave and the surface of the second partially reflective and transmissive element being convex.

20. The device of claim 16 wherein at least one of the partially reflective and transmissive elements is planar.
